(19) United States
(12) Patent Application Publication
(10) Pub. No.: US 2018/0126716 A1
(43) Pub. Date: May 10, 2018

(54) PRODUCTION OF COMPOSITE MATERIAL BY MEANS OF PLASMA COATING

(71) Applicants: THYSSENKRUPP STEEL EUROPE AG, Duisburg (DE); thyssenkrupp AG, Essen (DE)

(72) Inventors: Klaus-Peter KOCH, Schwelm (DE); Bernd SCHUHMACHER, Dortmund (DE); Michael STRACK, Recklinghausen (DE)

(73) Assignees: THYSSENKRUPP STEEL EUROPE AG, Duisburg (DE); thyssenkrupp AG, Essen (DE)

(21) Appl. No.: 15/574,520

(22) PCT Filed: May 19, 2016
(86) PCT No.: PCT/EP2016/061250

§ 371 Date: Nov. 16, 2017

(30) Foreign Application Priority Data
May 26, 2015 (DE) 10 2015 108 237.3

(51) Int. Cl. B32B 37/20; B32B 38/00

(52) U.S. Cl. CPC B32B 37/203; B05D 1/62; B32B 38/0008

(57) ABSTRACT

A process may be employed to produce a composite material having at least one metallic substrate and at least one polymer layer. The process may comprise applying an adhesion promoter layer across a surface of the metallic substrate and/or the polymer layer by means of plasma coating by a plasma coating system. The adhesion promoter layer may be created by driving the plasma coating system during the plasma coating such that a specific profile of the adhesion promoter layer across the surface of the metallic substrate and/or the polymer layer is established at least in some regions. The process may also involve bonding the polymer layer to the surface of the metallic substrate having the adhesion promoter layer and/or bonding the metallic substrate to the surface of the polymer layer having the adhesion promoter layer to produce the composite material.

The invention relates to a process for producing a composite material comprising at least one metallic substrate and at least one polymer layer, and to an apparatus for producing a composite material comprising at least one metallic substrate and at least one polymer layer. The invention additionally relates to a composite material comprising at least one metallic substrate, at least one polymer layer, and at least one adhesion promoter layer arranged in between.

The use of composite materials of the generic type, for example sandwich sheets having a thermoplastic polymer layer between two thin metallic outer layers, is advantageous in the implementation of lightweight construction concepts in the motor vehicle sector. Using these composite materials, it is possible to further increase the potentials for weight-saving in motor vehicle construction. Moreover, composite materials can provide various advantageous properties that are frequently mutually exclusive. For instance, composite materials of the generic type, owing to the polymer layer, have a much lower weight than solid sheets and, at the same time, provide higher strength values. Furthermore, the composite materials can be sound absorbing and offer high stiffness.

For bonding of the polymer layer to the metallic substrates, an adhesion promoter layer may be provided between the metallic substrate and polymer layer. The adhesion promoter layer is applied to the metallic strips, for instance, using wet-chemical methods, such as roll coating, spraying or dip coating.

However, it may be necessary for the composite materials, depending on the customer-specific requirements, to have regions with different properties. This may be necessary since different regions may be subject to different demands. For example, particular regions may be subject to higher degrees of deformation than others. In the case of use of the laminar composite materials as bodywork elements, it may likewise be desirable for there to be regions having particular properties or exhibiting particular characteristics in the event of an accident. In principle, it would be conceivable to achieve this, for instance, by means of correspondingly tailored outer layers or polymer layers. However, this leads to complex production processes.

Proceeding from this prior art, it is an object of the present invention to specify a process, an apparatus and a composite material, wherein it is possible to achieve, in a simple manner and in a reliable process, matching of properties of the composite material in such a way that they are tailored to the respective end use.

The object is achieved, according to a first teaching of the invention, in a process of the generic type, in that the process comprises the steps of:
providing the metallic substrate and the polymer layer,
applying an adhesion promoter layer across a surface of the metallic substrate and/or the polymer layer by means of plasma coating by a plasma coating system, the adhesion promoter layer being created by driving the plasma coating system during the plasma coating such that a specific profile of the adhesion promoter layer across the surface of the metallic substrate and/or the polymer layer is established at least in some regions, and
bonding the polymer layer to the surface of the metallic substrate having the adhesion promoter layer and/or bonding the metallic substrate to the surface of the polymer layer having the adhesion promoter layer in order to produce the composite material.

What is firstly achieved by the applying of the adhesion promoter layer across the surface of the metallic substrate and/or the polymer layer by means of plasma coating is that it is possible to achieve very strong bonding properties between the individual layers of the composite material. Bonding properties of this kind have not been achievable to date with conventional adhesion promoter layers, for example by wet-chemical methods, for instance roll coating, spraying or dip coating applied.

At the same time, what is achieved by the driving of the plasma coating system during the plasma coating is that it is possible to achieve precise influencing of the creation of the adhesion promoter layer during the coating. The effect of this is that a controlled profile of the adhesion promoter layer across the surface of the metallic substrate and/or the polymer layer is achieved, which was not possible by existing processes. For example, it is also possible to take account of deviations that occur only during the coating (in the case of metal strips, for example, a change in the strip running speed).

Establishment of a controlled profile of the adhesion promoter layer is especially understood to mean that the properties of the adhesion promoter layer (for example the thickness of the adhesion promoter layer, the density of the adhesion promoter layer, the composition of the adhesion promoter layer, the surface structure of the adhesion promoter layer etc.) across the surface of the metallic substrate and/or the polymer layer are controlled. This allows the resulting bond strength to be adjusted in a locally precise and resource-efficient manner.

The establishment of a controlled profile of the adhesion promoter layer may be based, for example, on specifications in respect of particular properties for the adhesion promoter layer. It is likewise conceivable that specifications are made in respect of the bond strength which is used as the basis on which the plasma coating system is driven.

The coating across the surface can be achieved, for example, via a relative movement of the metallic substrate and/or the polymer layer and the plasma coating system.

The composite material may also have more than one metallic substrate and/or more than one polymer layer. In this respect, the metallic substrate is understood to mean at least one metallic substrate. The composite material is, for example, a sandwich sheet having two metallic outer layers as metallic substrates and a thermoplastic polymer layer, for example, arranged in between.

It is likewise possible for more than one plasma coating system to be provided. In this respect, the plasma coating system is understood to mean at least one plasma coating system. For example, one plasma coating system is provided for each metallic substrate and/or polymer layer.

The metallic substrate is, for example, a sheet or is in strip form, for example a metal strip.

A strip may be provided, for example, by means of a coil from which it is unwound. For example, the coating of the strip is effected in-line with the step of bonding of the individual layers, for example in a laminating system.

The metallic substrate is, for example, an uncoated or coated substrate. For example, the metallic substrate consists of steel, especially stainless steel, aluminum, an aluminum alloy, magnesium, a magnesium alloy, zinc, copper, titanium, or combinations of these. A coated metallic substrate may be zinc-coated, zinc/magnesium-coated or chromium-coated or have an aluminum-based coating. For example, the metallic substrate has been electrolytically galvanized or electrolytically chrome-plated or has been subjected to zinc-based or aluminum-based hot dip coating.

The polymer layer is, for example, a polymer, preferably a thermoplastic polymer.

In a preferred configuration of the process according to the invention, the specific profile of the adhesion promoter layer across the surface of the metallic substrate and/or the polymer layer is a profile which is homogeneous in a controlled manner or varies in a controlled manner across the surface.

If a profile of the adhesion promoter layer which is homogeneous in a controlled manner across the surface is provided, a rise in resource efficiency can be achieved. For example, the driving of the plasma coating system during the plasma coating can achieve matching of the coating to the strip speed, such that resources, such as precursor material, are used optimally.

If, in a particularly advantageous configuration, a profile of the adhesion promoter layer that varies in a controlled manner across the surface is envisaged, it is possible for deliberately inhomogeneous bond strengths to be established in a precise manner. For example, regions of the laminar composite material which are exposed (at a later stage) to elevated deformation may be provided with elevated bond strength in order to prevent detachment of the individual layers. For example, regions of a composite material used as bodywork element which are to deliberately delaminate in the event of a crash may be provided selectively with reduced bond strength. The driving of the plasma coating system in this case too can take account of changes that occur during the coating, such as a change in the strip speed.

In one advantageous configuration of the process of the invention, the plasma coating system comprises multiple plasma modules and the driving of the plasma coating system comprises at least partly separate driving of the plasma modules. This provides a way of achieving, in particular, a profile of the adhesion promoter layer that varies in a controlled manner. The required local precision in the application of the adhesion promoter layer can be achieved, for example, via the arrangement and number of plasma modules. According to the requirements, the arrangement, on the basis of the individual modules, can be altered, extended or reduced in a flexible manner. Multiple plasma modules may, for example, be two plasma modules, three plasma modules, four plasma modules, etc. In a further configuration of the process of the invention, the multiple plasma modules are arranged adjacent to one another, especially in the manner of a matrix, across the surface of the metallic substrate and/or the polymer layer. This also allows complex profiles of the adhesion promoter layer to be achieved via a comparatively simple arrangement of the individual plasma modules of the plasma coating system. For example, two or more plasma modules may be arranged in an adjacent manner. For example, two or more plasma modules may be arranged alongside one another in a first direction and/or two or more plasma modules may be arranged alongside one another in a second direction (for example transverse to the first direction). For example, the plasma modules are arranged in the manner of a matrix in a 2×1 matrix, 1×2 matrix, 2×2 matrix etc. If the metallic substrate and/or the polymer layer is elongated, for example, the plasma modules, viewed in longitudinal direction, may be arranged one behind another and/or one beside another, for example.

In one configuration of the process of the invention, the driving of the plasma coating system brings about a change in the relative position of at least a portion of the plasma coating system, especially of one or more plasma modules, relative to the metallic substrate and/or relative to the polymer layer. This provides a way of achieving, in particular, a profile of the adhesion promoter layer that varies in a controlled manner, even without having to change process parameters of the plasma coating system or individual plasma modules. Instead, the plasma coating system or a portion thereof, for instance one plasma module, can be moved during the coating. In principle, this configuration is also possible, however, in combination with other configurations of the driving of the plasma coating system for establishment of a controlled profile.

In a further configuration of the process of the invention, the plasma coating comprises one or more of the steps of:
providing a process gas,
generating a plasma,
feeding a precursor for creation of the adhesion promoter layer into the plasma or the plasma afterglow and
at least partly depositing a plasma-polymerized adhesion promoter layer on the metallic substrate and/or the polymer layer.

It has been found that, in the case of such a plasma coating operation, efficient and precise adjustment of the bond strength across the adhesion promoter layer is possible. Preferably, the plasma coating is effected under atmospheric pressure. This allows the plasma coating to be implemented in a comparatively simple manner, since there is no need to provide any vacuum chamber or pressure chamber. The plasma may be generated, for example, between a first electrode and a second electrode. In this case, the metallic substrate may advantageously likewise constitute one of the electrodes. The thickness of the adhesion promoter layer may, for example, be between 2 and 50 nm or vary between these values, which leads to a reliable bond strength and sufficient freedom in the adjustment of the bond strength.

The precursor may, for example, be pulverulent, liquid or gaseous. For example, a liquid precursor can be atomized and fed in as an aerosol with a carrier gas. The precursor comprises, for example, an organic acid, especially an organic carboxylic acid, preferably acrylic acid or methacrylic acid. The precursor may comprise, for example, allylamine, allyl methacrylate, hydroxyethyl acrylate, (3-aminopropyl)triethoxysilane and/or (3-glycidoxypropyl)trimethoxysilane.

The process gas comprises, for example, N₂, CO₂, Ar and/or He. In addition, the process gas may comprise hydrogen as reactive gas (for example max. 5%).

In a further configuration of the process of the invention, the driving of the plasma coating system brings about a change in one or more process parameters of the plasma coating system, especially one or more plasma modules, especially in a process parameter relating to a plasma power, a precursor feed and/or a process gas. The change in one or more process parameters during the plasma coating operation provides a way of achieving, in particular, a profile of the adhesion promoter layer that varies in a controlled manner. If one process parameter in a single plasma module is changed, a further increase in spatial resolution of the profile of the adhesion promoter layer can be achieved. A process parameter relating to the plasma power may, for example, be a change in the electrode voltage. A change in a process parameter relating to the precursor feed may, for example, be a change in the composition of the precursor or the flow rate of the precursor. A change in a process parameter relating to the process gas may, for example, be a change in the composition of the process gas or the flow rate of the process gas.

The driving of the plasma coating system may likewise be a change in one or more process parameters in just part of a plasma module of a plasma coating system, in order to further increase the spatial resolution.

In a further configuration of the process of the invention, the plasma coating system, especially one or more plasma modules of the plasma coating system, has multiple feed points, and the driving of the plasma coating system comprises at least partly separate driving of the feed at the multiple feed points. This can achieve a further increase in spatial resolution of the controlled profile of the adhesion promoter layer. The driving of the feed can achieve, for example, a change in the feed parameters, for example in the precursor composition or volume, or the process gas composition or volume.

In a further configuration of the process of the invention, the plasma coating system is driven as a function of an at least partly defined bond strength profile. It is thus possible to define, for example, a spatially resolved bond strength profile from which the specific profile of the adhesion promoter layer is then determined. For this purpose, for example, a control unit is provided, which at least partly conducts the driving of the plasma coating system. For example, the manner in which the plasma coating system is driven for establishment of the specific profile of the adhesion promoter layer can be determined on the basis of one or more characteristics and/or one or more calculation modules. Advantageously, it is possible here to take account of the current strip speed in the case of a metallic substrate and/or polymer layer in strip form.

In a further advantageous configuration of the process of the invention, the composite material comprises a first metallic substrate and a second metallic substrate, wherein the polymer layer is arranged between the first and second metallic substrates, and the adhesion promoter layer is applied to the first and/or second metallic substrate and/or to the polymer layer. In this way, it is possible to use the configuration of the process of the invention, in particular, for production of sandwich sheets. The embodiments relating to the metallic substrate described above are applicable to the first and second metallic substrates. These first and second metallic substrates may be the same or different. It is also possible for more than two metallic substrates to be provided.

In a further advantageous configuration of the process of the invention, the first metallic substrate is coated by means of a first plasma coating system and the second metallic substrate is coated by means of a second plasma coating system. It is possible here for the first and/or second plasma coating system to be a plasma coating system described above. It is also possible for further plasma coating systems as described above to be provided. The plasma coating systems here may also independently have individual features among those described above. For example, the plasma coating systems are the same or different.

In this way, controlled tuning of the bond strengths of the two metallic substrates with respect to the polymer layer arranged in between is possible. It is thus possible to adjust the bond strength in a controlled manner not just over the area (i.e. 2-dimensionally) between two layers of the composite material, but it is also possible to adjust the bond strength with regard to different layers of the laminar composite material, i.e. with regard to a further dimension (i.e. 3-dimensionally). For example, it is possible to adjust not only the point at which a layer is to delaminate in a controlled manner, but also which of the layers is to delaminate in a controlled manner under stress.

According to a second teaching of the present invention, in an apparatus of the generic type, especially for performance of the process of the invention, the object stated at the outset is achieved in that the apparatus comprises:
a unit for providing the metallic substrate and the polymer layer,
a plasma coating system for applying an adhesion promoter layer across a surface of the metallic substrate and/or the polymer layer by means of plasma coating,
a control unit for driving the plasma coating system during the plasma coating for creation of the adhesion promoter layer, such that a specific profile of the adhesion promoter layer across the surface of the metallic substrate and/or the polymer layer can be established at least in some regions, and
a unit for bonding the polymer layer to the surface of the metallic substrate having the adhesion promoter layer and/or bonding the metallic substrate to the surface of the polymer layer having the adhesion promoter layer in order to produce the composite material.

As explained above, the applying of the adhesion promoter layer across the surface of the metallic substrate and/or the polymer layer by means of plasma coating achieves very high bonding properties between the individual layers of the composite material. In addition, the providing of a control unit achieves the driving of the plasma coating system during the plasma coating, such that it is possible to achieve precise influencing of the creation adhesion promoter layer during the coating. In this way, it is possible to adjust the resulting bond strength in a locally precise and resource-efficient manner.

With regard to advantageous configurations of the apparatus of the invention, reference is made to the details given in relation to the process of the invention and configurations thereof, which are to apply correspondingly to the apparatus.

More particularly, the preceding and subsequent description of process steps of preferred embodiments of the process shall also constitute a disclosure of corresponding means or units for performance of the process steps via preferred embodiments of the apparatus. The disclosure of means of performing a process step shall also constitute a disclosure of the corresponding process step.

In a third teaching of the process of the invention, the object stated at the outset is achieved in a composite material of the generic type in that the composite material has been produced by a process of the invention.

In one configuration of the composite material of the invention, the specific profile of the adhesion promoter layer across the surface of the metallic substrate and/or the polymer layer has a profile that varies in a controlled manner, such that the composite material has regions with different bond strength.

By contrast with known composite materials, configurations of the composite material of the invention have improved bond strengths. In addition, configurations of the composite material of the invention have a precisely adjusted varying bond strength, and not only is it possible to control the bond strength locally within an adhesion promoter layer, but it is also possible to match different adhesion promoter layers to one another in a controlled manner.

The invention is to be elucidated in detail hereinafter with reference to working examples in conjunction with the drawing. The drawing shows, in

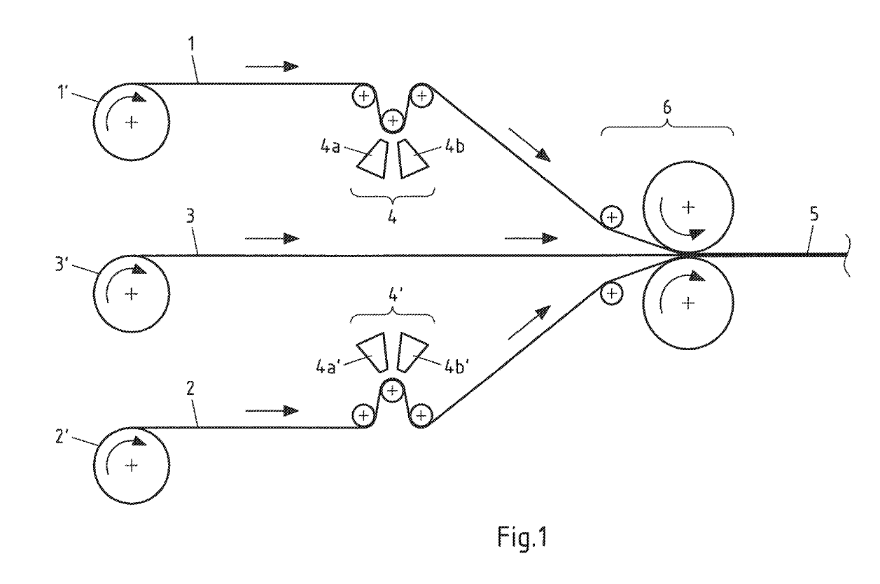

FIG. 1 a schematic diagram of a working example of an apparatus of the invention for performing a working example of a process of the invention;

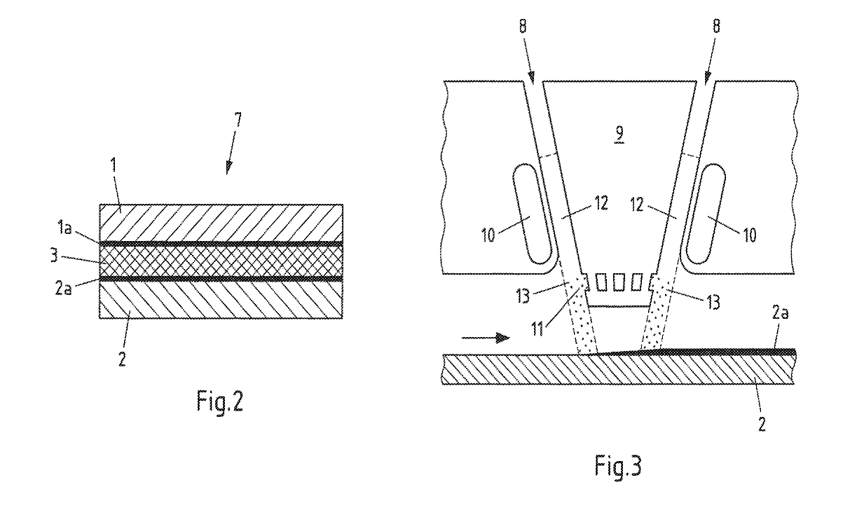

FIG. 2 a schematic cross-sectional view of a working example of a composite material of the invention;

FIG. 3 a working example of a plasma coating step;

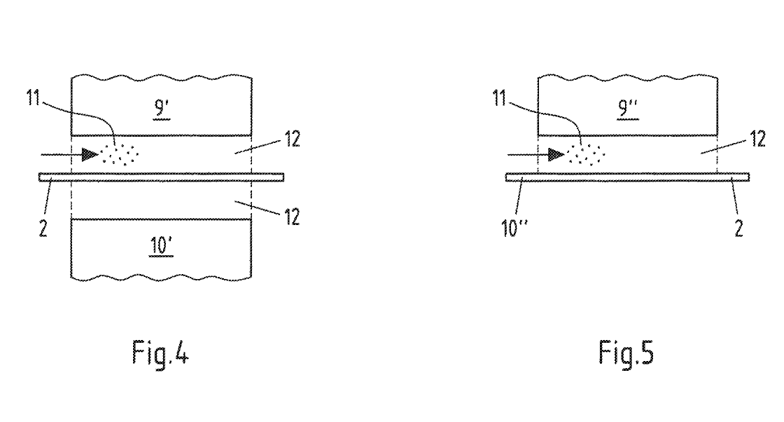

FIGS. 4-5 different working examples of plasma coating steps;

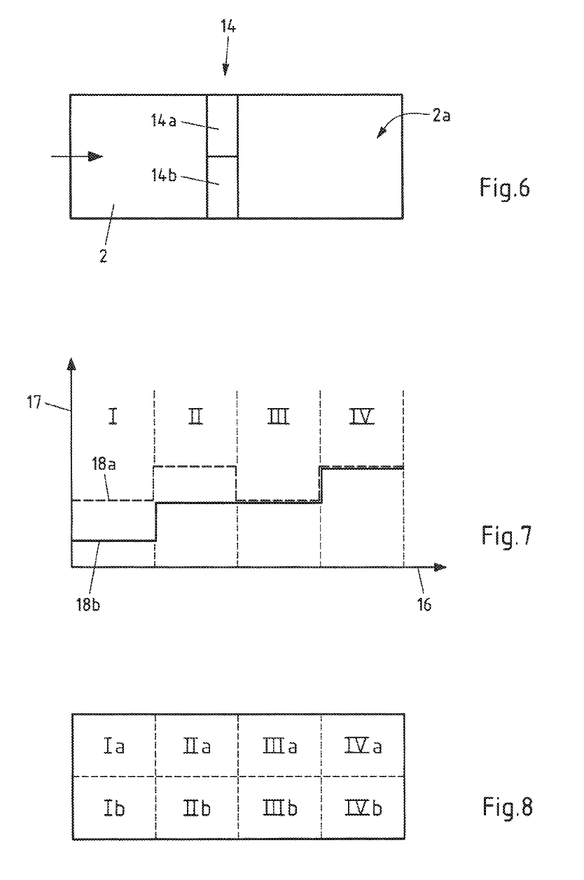

FIG. 6 a schematic top view of an alternative arrangement of the plasma modules;

FIG. 7 a schematic diagram of a sequence of controlled process parameters;

FIG. 8 a schematic diagram of a metallic substrate having an adhesion promoter layer with a profile that varies in a controlled manner.

FIG. 1 shows a schematic diagram of a working example of an apparatus of the invention for performing a working example of a process of the invention. The metallic substrates provided are a first and second metal strip 1, 2 which are unwound from the coils 1′, 2′ by an unwinding apparatus (not shown). On a third coil 3′, a thermoplastic interlayer 3 is provided. In this way, units for provision of the metallic substrates and the polymer layer are implemented. Each metal strip 1, 2 is plasma-coated by the plasma coating systems 4, 4′, which serve to apply an adhesion promoter layer across the respective surfaces of the metal strips 1, 2 by means of plasma coating. A conceivable alternative would be for one or both plasma coating systems 4, 4′ to coat the polymer layer 3 on one or both sides. In this case, each plasma coating system 4, 4′ has two plasma modules 4a and 4b or 4a′ and 4b′. These plasma modules 4a, 4b or 4a′, 4b′ are arranged in series in strip running direction (as indicated by the arrows). Further details of the plasma modules are described further down. After the coating of the respective inner surfaces of the two metal strips 1, 2 that face the polymer layer 3, the metal strips 1, 2 and the polymer layer 3 are bonded by laminating to form a composite material 5 in strip form. This is effected by means of a laminating unit 6, which serves as a unit for bonding the polymer layer 3 to the surfaces of the respective metal strip 1, 2 having the adhesion promoter layers for production of the laminar composite material 5 and is likewise shown in schematic form. The plasma coating of the metal strips 1, 2 with a plasma-polymerized adhesion promoter layer can achieve an advantageous bond strength of the composite material 5 after the laminating by means of the laminating unit 6.

The apparatus shown in FIG. 1 also has a control unit (not shown) for separate driving of the plasma modules of the plasma coating systems 4, 4′ during the plasma coating for creation of the adhesion promoter layer. It is thus possible to establish a specific profile, for example a profile of the adhesion promoter layer that varies in a controlled manner across the surface of the metal strips 1, 2 at least in some regions.

The plasma coating preferably proceeds at atmospheric pressure. This involves providing a process gas, generating a plasma, feeding a precursor for creation of the adhesion promoter layer into the plasma or the plasma afterglow, and depositing a plasma-polymerized adhesion promoter layer on the respective metal strip 1, 2.

FIG. 2 shows a schematic cross-sectional view of a working example of a composite material of the invention in the form of a composite sheet 7 which has been produced from the composite material 5 in strip form. The composite sheet 7 comprises 2 metallic outer sheets 1, 2, for example steel sheets. Each metallic outer sheet 1, 2 has a surface with plasma-polymerized adhesion promoter layers 1a, 1b facing the thermoplastic polymer layer 3, these having a profile matched to the use region in a locally specific manner.

FIG. 3 shows, by way of example, a working example of a plasma coating step, here for the metal strip 2 by way of example. The plasma coating can thus proceed, for example, in the plasma modules 4′, 4b, 4a′, 4b′. The process gas 8 flows through between a first electrode 9 and a second electrode 10. A plasma 12 is formed between the first and second electrodes 9, 10. The plasma afterglow may extend as far as the surface of the metal strip 2. An aerosol 11 is fed into the plasma afterglow 13. The aerosol is formed by a carrier gas and a liquid precursor and, together with the process gas 8 and the plasma, is directed to the inside of the metal strip 2. This results in deposition of the plasma-polymerized precursor as an adhesion promoter layer 2a on the metal strip 2. The plasma 12 or the plasma afterglow 13 activates the surface of the metal strip 2 and the precursor present in the aerosol. The relative movement of metal strip 2 and plasma coating system 4, 4′ results in buildup of a very thin coating by means of the plasma-polymerized adhesion promoter layer 2a on the metal strip 2, which may have a thickness of, for example, 2 to 50 nm, preferably 5 to 30 nm.

FIG. 4 shows an alternative working example of a plasma coating step, here by way of example for the metal strip 2. The plasma 12 in this case is generated by means of electrodes 9′, 10′ arranged on either side of the metal strip 2. As shown by the arrow, the aerosol 11 is fed into the plasma 12, which leads to deposition of a plasma-polymerized adhesion promoter layer 2a on the metal strip. Rather than an aerosol, it is also possible to feed in a gaseous precursor.

FIG. 5 shows a further alternative working example of a plasma coating step, again by way of example for the metal strip 2. The plasma 12 is generated between the first electrode 9″ and the metallic substrate 2, which functions as a second electrode.

FIG. 6 shows a schematic top view of an alternative arrangement of the plasma modules. In this case, a plasma coating system 14 comprising two plasma modules 14a, 14b is provided above a metallic substrate which is the metal strip 2 here, but may also be the metal strip 1. The plasma modules may be constructed, for example, as shown in FIGS. 3-5 and be used as shown in FIG. 1. By contrast with the plasma modules 4a, 4b, 4a′, 4b′ shown in FIG. 1, the plasma modules 14a, 14b are not arranged one behind another but one alongside another, in other words at right angles to the strip running direction shown by the arrow. The plasma coating system 14 applies an adhesion promoter layer across a surface of the metallic substrate 2 by means of plasma coating. For creation of the adhesion promoter layer 2a, the plasma coating system 14 is driven here during the plasma coating such that a profile of the adhesion promoter layer that varies in a controlled manner across the surface of the metal strip 2 is established at least in some regions.

For this purpose, FIG. 7 shows a schematic diagram of a sequence of controlled process parameters. The diagram shows time along the x axis 16 and the size of a process parameter 18a of the plasma module 14a and of a process parameter 18b of the plasma module 14b along the y axis 17. The plasma coating system 14 is driven such that a change in a process parameter of the plasma modules 14a, 14b of the plasma coating system 14 is achieved over time. The process parameter can affect the bond strength achieved by the adhesion promoter layer. In this case, a high value of the process parameter achieves a high bond strength and a low value of the process parameter a low bond strength. The process parameter may relate, for example, to the plasma power, the precursor feed or the process gas.

In this example, the process parameter 18a of the plasma module 14a in section I is at a low level, in section II and III at a moderate level, and in section IV at a high level. The process parameter 18b of the plasma module 14b in section I is at a moderate level, in section II at a high level, in section III at a moderate level, and in section IV at a high level. It is of course possible to provide other profiles in a corresponding manner. The control of the plasma parameters 18a, 18b may be based, for example, on deriving a specific profile of the adhesion promoter layer from a desired bond strength profile and using this to create the control of the process parameters, for which it is possible to use, for example, one or more characteristics and/or one or more calculation models. If the adhesion promoter layer 2a is applied with the specific profile, this leads to the desired bond strength profile. Advantageously, it is possible here to take account of the current strip speed of the metal strip 2.

FIG. 8 shows the metal strip 2 after the coating with the plasma-polymerized adhesion promoter layer 2a. In the region coated by the plasma module 14a, the metal strip 2 in section Ia has a low bond strength, in section IIa and IIIa a moderate bond strength, and in section IVa a high bond strength. In the region coated by the plasma module 14b, the metal strip 2 in section Ib has a moderate bond strength, in section IIb a high bond strength, in section IIIb a moderate bond strength, and in section IVb a high bond strength.

An identical or different profile of the adhesion promoter layer can be established, for example, on the surface of the metal strip 1. The metal strips 1, 2 and the polymer layer 3 can, as described, produce a composite material 5 or a composite sheet 7. The applying of the adhesion promoter layer according to a controlled profile across the surface of the metal strips by means of plasma coating allows the resulting bond strength to be adjusted in a locally precise and resource-efficient manner. Ultimately, the bond strength can be adjusted by a reliable process in three dimensions (on surfaces of metallic substrates arranged on top of another).

1.-14. (canceled)

15. A process for producing a composite material that includes a metallic substrate and a polymer layer, the process comprising:
applying an adhesion promoter layer across a surface of at least one of the metallic substrate or the polymer layer by way of plasma coating with a plasma coating system, wherein the adhesion promoter layer is created by driving the plasma coating system during the plasma coating such that a specific profile of the adhesion promoter layer is established at least in some regions across the surface; and
performing at least one of
bonding the polymer layer to the surface of the metallic substrate having the adhesion promoter layer, or
bonding the metallic substrate to the surface of the polymer layer having the adhesion promoter layer.

16. The process of claim 15 wherein the specific profile of the adhesion promoter layer is homogeneous in a controlled manner or varies in a controlled manner across the surface.

17. The process of claim 15 wherein the plasma coating system comprises plasma modules, wherein the driving of the plasma coating system comprises at least partly separate driving of the plasma modules.

18. The process of claim 17 wherein the plasma modules are disposed adjacent to one another across the surface of the at least one of the metallic substrate or the polymer layer.

19. The process of claim 17 wherein the plasma modules are disposed in a matrix across the surface of the at least one of the metallic substrate or the polymer layer.

20. The process of claim 15 wherein the driving of the plasma coating system causes at least a portion of the plasma coating system to change positions relative to at least one of the metallic substrate or the polymer layer.

21. The process of claim 15 wherein the driving of the plasma coating system causes at least one plasma module of the plasma coating system to change positions relative to at least one of the metallic substrate or the polymer layer.

22. The process of claim 15 wherein the plasma coating comprises:
providing a process gas;
generating a plasma;
feeding a precursor for the creation of the adhesion promoter layer into the plasma or a plasma afterglow; and
at least partly depositing a plasma-polymerized adhesion promoter layer on at least one of the metallic substrate or the polymer layer.

23. The process of claim 15 wherein the driving of the plasma coating system causes a change in at least one process parameter of the plasma coating system.

24. The process of claim 15 wherein the driving of the plasma coating system causes a change in at least one process parameter of the plasma coating system, the at least one process parameter relating to at least one of a plasma power, a precursor feed, or a process gas.

25. The process of claim 15 wherein the plasma coating system includes multiple feed points, wherein the driving of the plasma coating system comprises at least partly separate driving of feed at the multiple feed points.

26. The process of claim 15 wherein one or more plasma modules of the plasma coating system includes multiple feed points, wherein the driving of the plasma coating system comprises at least partly separate driving of feed at the multiple feed points.

27. The process of claim 15 wherein the plasma coating system is driven as a function of an at least partly defined bond strength profile.

28. The process of claim 15 wherein the metallic substrate is a first metallic substrate, wherein the composite material comprises the polymer layer disposed between the first metallic substrate and a second metallic substrate, wherein the adhesion promoter layer is applied across the surface of at least one of the first metallic substrate, the second metallic substrate, or the polymer layer by way of the plasma coating with the plasma coating system.

29. The process of claim 28 wherein the plasma coating system is a first plasma coating system, the process comprising:
plasma coating the first metallic substrate by way of the first plasma coating system; and
plasma coating the second metallic substrate by way of a second plasma coating system.

30. An apparatus for producing a composite material that includes a metallic substrate and a polymer layer, the apparatus comprising:
a plasma coating system for applying by way of plasma coating an adhesion promoter layer across a surface of at least one of the metallic substrate or the polymer layer;
a control unit for driving the plasma coating system during the plasma coating to establish a specific profile of the adhesion promoter layer at least in some regions across the surface of the at least one of the metallic substrate or the polymer layer; and
a unit for producing the composite layer by at least one of
bonding the polymer layer to the surface of the metallic substrate having the adhesion promoter layer, or
bonding the metallic substrate to the surface of the polymer layer having the adhesion promoter layer.

31. The apparatus of claim 30 wherein the plasma coating system comprises plasma modules that are individually actuatable.

32. The apparatus of claim 30 wherein the plasma coating system includes multiple feed points.

33. A composite material that includes a metallic substrate and a polymer layer, wherein the composite material is produced by a process that comprises:
applying an adhesion promoter layer across a surface of at least one of the metallic substrate or the polymer layer by way of plasma coating with a plasma coating system, wherein the adhesion promoter layer is created by driving the plasma coating system during the plasma coating such that a specific profile of the adhesion promoter layer is established at least in some regions across the surface; and
performing at least one of
bonding the polymer layer to the surface of the metallic substrate having the adhesion promoter layer, or
bonding the metallic substrate to the surface of the polymer layer having the adhesion promoter layer.

34. The composite material of claim 33 wherein the specific profile of the adhesion promoter layer varies in a controlled manner such that the composite material has regions with different bond strength.
